(19) United States
(12) Patent Application Publication
(10) Pub. No.: US 2024/0294160 A1
(43) Pub. Date: Sep. 5, 2024

(54) HYDRAULIC PRESSURE SUPPLY DEVICE AND ELECTRONIC BRAKE SYSTEM INCLUDING THE SAME

(71) Applicant: HL MANDO CORPORATION, Gyeonggi-do (KR)

(72) Inventor: Kwangseok HONG, Gyeonggi-do (KR)

(21) Appl. No.: 18/418,688

(22) Filed: Jan. 22, 2024

(30) Foreign Application Priority Data
Mar. 3, 2023 (KR) 10-2023-0028474

(51) Int. Cl. B60T 17/02; B60T 7/04; B60T 11/16; B60T 11/18; B60T 11/26; F04B 39/00

(52) U.S. Cl. CPC B60T 17/02; B60T 11/165; B60T 11/18; F04B 39/0044; B60T 7/042; B60T 11/26; B60T 2220/04

(57) ABSTRACT

The present disclosure relates to a hydraulic pressure supply device and an electronic brake system including the same, including: a hydraulic block formed with a flow path through which oil supplied from a reservoir flows; a motor pump unit coupled to one side of the hydraulic block, configured to generate drive force by supply of power and to move forward and backward by the drive force; a sleeve coupled to an inside of the hydraulic block on the other side of the hydraulic block and configured to form a forward and backward path of the motor pump unit; a housing coupled to the other side of the hydraulic block and configured to form a space for generating hydraulic pressure with the oil supplied from the reservoir while shielding the other side of the sleeve; and a damping member provided between the sleeve and the housing and configured to absorb vibration generated between the sleeve and the housing and to prevent noise when pressure in the space for generating the hydraulic pressure rises due to the forward and backward movement of the motor pump unit.

### CROSS-REFERENCE TO RELATED APPLICATIONS

This application claims benefit and priority to Korean Patent Application No. 10-2023-0028474, filed on Mar. 3, 2023 with the Korean Intellectual Property Office, the disclosure of which is incorporated herein in its entirety by reference.

### TECHNICAL FIELD

The present disclosure relates to a hydraulic pressure supply device and an electronic brake system including the same, and more particularly, to a hydraulic pressure supply device configured to generate and supply hydraulic pressure so that the hydraulic pressure can be transferred to a wheel cylinder in conjunction with a brake actuation in an electronic brake system, and an electronic brake system including the same.

### BACKGROUND

A brake system of the related art mainly uses a method of supplying hydraulic pressure necessary for braking to a wheel cylinder by means of a mechanically connected booster when a driver presses on a brake pedal.

However, as the market demand for implementing various braking functions in close correspondence with an operating environment of a vehicle is increasing, in recent years, an electronic brake system has been widely spread in which a driver's braking intention is transmitted as an electrical signal from a pedal displacement sensor that senses displacement of a brake pedal when the driver presses on the brake pedal, and based on the electrical signal, a hydraulic pressure supply device is actuated to supply hydraulic pressure necessary for braking to a wheel cylinder.

Such an electronic brake system generates and provides, as an electrical signal, a driver's pressing on the brake pedal during a normal actuating mode or a braking decision during a vehicle's autonomous driving, and based on the electrical signal, the hydraulic pressure supply device is electrically actuated and controlled to generate and transfer the hydraulic pressure necessary for braking to the wheel cylinder.

In the hydraulic pressure supply device provided in the electronic brake system, there are problems in that vibration is felt or noise is generated due to a shock when a piston moves forward and backward in a pump actuated to generate the hydraulic pressure, and the problems provide inconvenience to customers. Therefore, there is a need for a solution capable of preventing the generation of vibration and noise due to the shock at the time of generating the hydraulic pressure.

### SUMMARY

The present disclosure has been made in an effort to provide a hydraulic pressure supply device capable of preventing generation of vibration and noise due to a shock when a piston moves forward and backward due to an increase in pressure in a pump when generating hydraulic pressure so that the hydraulic pressure can be transferred to a wheel cylinder in conjunction with a brake actuation in an electronic brake system, and an electronic brake system including the same.

An exemplary embodiment of the present disclosure provides a hydraulic pressure supply device including: a hydraulic block formed with a flow path through which oil supplied from a reservoir flows; a motor pump unit coupled to one side of the hydraulic block, configured to generate drive force by supply of power and to move forward and backward by the drive force; a sleeve coupled to an inside of the hydraulic block on the other side of the hydraulic block and configured to form a forward and backward path of the motor pump unit; a housing coupled to the other side of the hydraulic block and configured to form a space for generating hydraulic pressure with the oil supplied from the reservoir while shielding the other side of the sleeve; and a damping member provided between the sleeve and the housing and configured to absorb vibration generated between the sleeve and the housing and to prevent noise when pressure in the space for generating the hydraulic pressure rises due to the forward and backward movement of the motor pump unit.

The damping member may include a tubular damping body having a hollow portion formed along a longitudinal direction so that the sleeve is able to be inserted and coupled thereto; and a slit formed penetrating through an inside and outside of the damping body.

The slit may be formed in plural, spaced apart from each other by a set distance along a circumferential direction of the damping body.

The slit may include an inclined portion formed to be inclined downward from an upper side toward the other side; a first extension portion extending by a set length along the circumferential direction of the damping body from any one of the upper and lower sides of the inclined portion; and a second extension portion extending by a set length along the circumferential direction of the damping body from the other of the upper and lower sides of the inclined portion.

The sleeve may include a tubular sleeve body having a hollow portion along a longitudinal direction, and the sleeve body may have a damping member coupling part formed so that the damping member is able to be coupled by a set length from one side toward the other side.

The damping member coupling part may include a damping member contact surface having a diameter smaller than a diameter of an outer circumferential surface of the sleeve body and configured to be in contact with an inner surface of the damping member; and a stepped surface configured to connect the damping member contact surface and an outer surface of the sleeve body.

The damping member contact surface may include a contact surface whose cross section is formed to be uniform by a set length from the stepped surface toward one side of the sleeve; and a separation surface whose cross section is formed to gradually decrease from the contact surface to one side of the sleeve.

An inner surface of the damping member may be configured to be in close contact with the contact surface when the damping member is coupled to the damping member coupling part.

A height of the damping member may be formed longer than a height of the damping member contact surface.

The damping member may be formed of a plastic material.

The damping member may include a tubular damping body having a hollow portion formed along a longitudinal direction so that the sleeve is able to be inserted and coupled thereto.

The damping body may include a first groove formed concave on an outer surface and extending along a circumferential direction of the damping body; a plurality of second grooves formed concave on an upper side toward a lower side by a set depth, and spaced apart from each other by a set angle along a circumferential direction of the damping body; and a plurality of third grooves formed to be concave on a lower side toward the upper side by a set depth, and spaced apart from each other by a set angle along the circumferential direction of the damping body.

The damping member may be formed of a rubber material.

The motor pump unit may include a motor coupled to one side of the hydraulic block and configured to generate drive force by supply of power; and a pump member inserted into the hydraulic block from one side of the hydraulic block and configured to move forward and backward by the drive force generated by the motor.

Another exemplary embodiment of the present disclosure provides an electronic brake system including: a reservoir in which oil is stored; a master cylinder configured to provide a pedal feeling to a driver while discharging the oil by an operation of a brake pedal; and a hydraulic pressure supply device configured to generate hydraulic pressure by actuating a hydraulic piston by an electrical signal that is output in response to displacement of the brake pedal, in which the hydraulic pressure supply device includes a hydraulic block formed with a flow path through which the oil supplied from the reservoir flows; a motor coupled to one side of the hydraulic block, and configured to generate drive force by supply of power; a pump member coupled into the hydraulic block from one side of the hydraulic block and configured to move forward and backward by the drive force provided by the motor; and a housing unit configured to form a path through which the pump member moves forward and backward and to form a space for generating hydraulic pressure by storing the oil, and coupled into the hydraulic block from the other side of the hydraulic block, and in which the housing unit includes a damping member configured to absorb vibration and to prevent noise generated while pressure in the space for generating the hydraulic pressure rises due to the forward and backward movement of the pump member.

The housing unit may include a sleeve inserted into the hydraulic block from the other side of the hydraulic block and configured to form a path through which the pump member moves forward and backward; and a housing coupled to the other side of the hydraulic block and configured to form a space for generating hydraulic pressure by storing the oil while shielding the other side of the sleeve.

The damping member may include a tubular damping body having a hollow portion formed along a longitudinal direction so that the sleeve is able to be inserted and coupled thereto; and a slit formed penetrating through an inside and outside of the damping body.

The slit may be formed in plural, spaced apart from each other by a set distance along a circumferential direction of the damping body.

The slit may include an inclined portion formed to be inclined downward from an upper side toward the other side; a first extension portion extending by a set length along the circumferential direction of the damping body from any one of the upper and lower sides of the inclined portion; and a second extension portion extending by a set length along the circumferential direction of the damping body from the other of the upper and lower sides of the inclined portion.

The sleeve may include a tubular sleeve body having a hollow portion along a longitudinal direction, and the sleeve body may have a damping member coupling part formed so that the damping member is able to be coupled by a set length from one side toward the other side.

Details of other exemplary embodiments are included in the detailed description and drawings.

According to the exemplary embodiments of the present disclosure, the hydraulic pressure supply device and the electronic brake system including the same according to the present disclosure have the following effects.

First, the damping member is provided between the housing and the sleeve, so that it is possible to prevent vibration and noise generated due to the forward and backward movement of the piston member when the internal pressure rises.

Second, the damping member can absorb vibration, and transfer load to the sleeve and the housing to prevent vibration from occurring.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram showing a configuration of an electronic brake system including a hydraulic pressure supply device according to an exemplary embodiment of the present disclosure.

FIG. 2 is a cross-sectional view showing a part of the hydraulic pressure supply device according to the exemplary embodiment of the present disclosure.

FIG. 3 is a perspective view showing a damping member of the hydraulic pressure supply device according to the exemplary embodiment of the present disclosure.

FIG. 4 is a perspective view showing a damping member of a hydraulic pressure supply device according to another exemplary embodiment of the present disclosure.

FIG. 5 is a partial cross-sectional view showing an exemplary embodiment to which the damping member of FIG. 3 is applied.

FIG. 6 is a partial cross-sectional view showing an exemplary embodiment to which the damping member of FIG. 4 is applied.

### DETAILED DESCRIPTION

In the following detailed description, reference is made to the accompanying drawing, which forms a part hereof. The illustrative embodiments described in the detailed description, drawing, and claims are not meant to be limiting. Other embodiments may be utilized, and other changes may be made, without departing from the spirit or scope of the subject matter presented here.

Hereinafter, exemplary embodiments of the present disclosure will be described in detail so that one skilled in the art to which the present disclosure belongs can easily implement the present disclosure. The present disclosure may be implemented in various different forms, and is not limited to the exemplary embodiments described herein.

It should be noted that the drawings are schematic and not drawn to scale. The relative dimensions and ratios of the parts in the drawings are shown exaggerated or reduced in size for clarity and convenience in the drawings, and any dimension is merely exemplary and not limiting. In addition, the same reference numerals are used to denote similar features in the same structures, elements, or parts shown in two or more drawings.

The exemplary embodiments of the present disclosure specifically show preferred exemplary embodiments. As a result, various modifications of the drawings are anticipated. Therefore, the exemplary embodiments are not limited to a specific form of an illustrated region, and, for example, include modifications of a manufactured form.

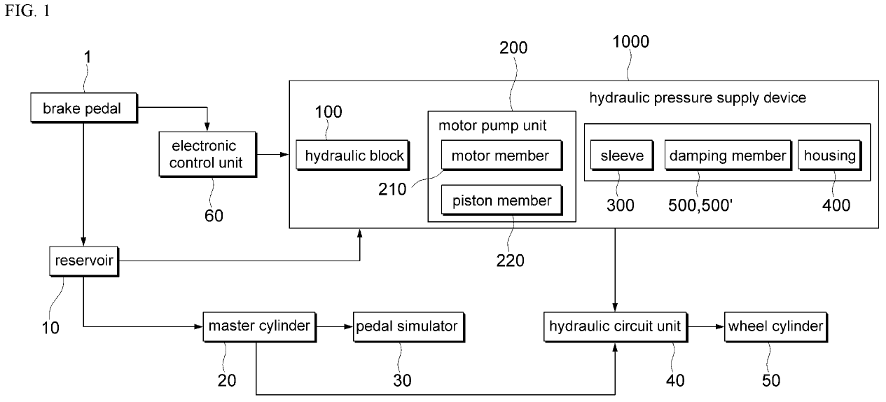

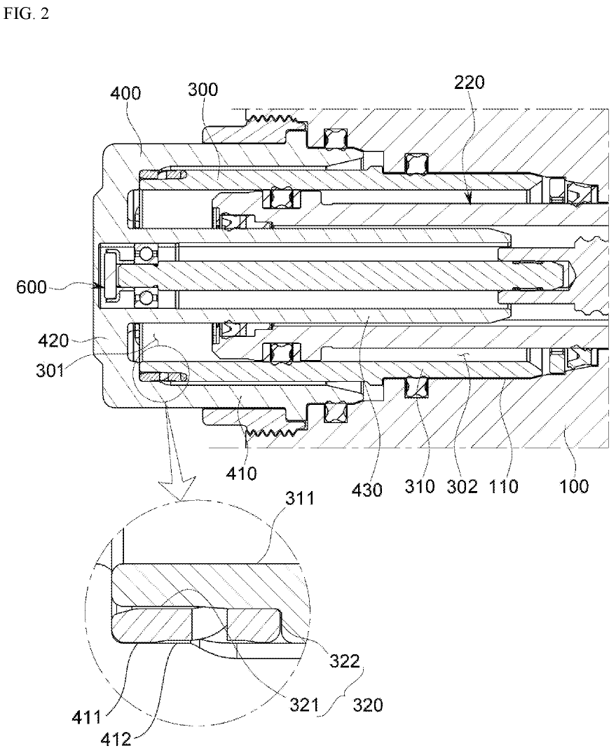

Hereinafter, the hydraulic pressure supply device according to the present disclosure will be described in detail with reference to FIGS. 1 to 6.

The hydraulic pressure supply device is provided in an electronic brake system. The electronic brake system includes a reservoir 10, a brake pedal 1, a master cylinder 20, a pedal simulator 30, a hydraulic circuit unit 40, an electronic control unit 60, and a hydraulic pressure supply device 1000.

The reservoir 10 stores oil, which is a working fluid.

The master cylinder 20 receives the oil from the reservoir 10. The master cylinder 20 generates hydraulic pressure to be supplied to the hydraulic circuit unit 60 with the supplied oil. Specifically, when the brake pedal 1 is operated by a driver, the master cylinder 20 is pressurized to generate hydraulic pressure.

The hydraulic pressure generated in the master cylinder 20 is transferred to the pedal simulator 30. The pedal simulator 30 provides a reaction force to pedal force on the brake pedal 1 to the driver through the hydraulic pressure generated in the master cylinder 20. This makes it possible for the driver to finely tune actuation of the brake pedal 1 and the braking force of a vehicle.

Meanwhile, when an emergency such as electric power not being supplied to the whole system occurs, the hydraulic pressure of the master cylinder 20 is directly transferred to the wheel cylinder 40, and therefore, the vehicle can be braked.

An electrical signal is transmitted to the electronic control unit 60, in response to displacement sensed on the brake pedal 1. The electronic control unit 60 outputs a signal so that the hydraulic pressure supply device 1000 can be actuated according to the transmitted electrical signal. Specifically, a signal is output so that a motor member 210 of a motor pump unit 200 described later can be actuated.

The hydraulic pressure generated in the hydraulic pressure supply device 1000 is also supplied to the wheel cylinder 50 via the hydraulic circuit unit 40. The hydraulic pressure supply device 1000 will be described in more detail later.

The hydraulic pressure supply device 1000 according to an exemplary embodiment of the present disclosure includes a hydraulic block 100, a motor pump unit 200, a sleeve 300, a housing 400, and a damping member 500.

The hydraulic block 100 is formed with a flow path (not shown) through which the oil supplied from the reservoir 10 flows. The hydraulic block 100 is formed with a coupling hole 110 penetrating in a width direction or a thickness direction.

The motor pump unit 200, the sleeve 300, and the housing 400 are coupled to the hydraulic block 100, and in this case, the motor pump unit 200, the sleeve 300 and the housing 400 are coupled through the coupling hole 110.

The motor pump unit 200 is coupled while being inserted into the hydraulic block 100 from one side of the hydraulic block 100. Specifically, the motor pump unit is inserted and coupled into the coupling hole 110 from one side of the hydraulic block 100.

The motor pump unit 200 includes a motor member 210 and a piston member 220.

When power is supplied, the motor member 210 rotates to generate drive force, and provides the drive force to the piston member 220. Although not shown in the drawings, the motor member 210 includes a motor (not shown) and a ball screw part (not shown). When power is supplied, the motor (not shown) rotates, and the ball screw part (not shown) rotates in conjunction with the rotation of the motor (not shown). The ball screw part (not shown) is configured to convert rotational motion into linear motion.

One side of the piston member 220 is coupled to the motor member 210, and the other side is inserted into the sleeve 300. The piston member 220 moves forward and backward by the drive force provided from the motor member 210. Specifically, since the piston member 220 is connected to the ball screw part (not shown), the piston member 220 can move forward and backward by the linear motion converted by the ball screw part (not shown).

The sleeve 300 is inserted and coupled into the hydraulic block 100 from the other side of the hydraulic block 100. Specifically, the sleeve is inserted into the coupling hole 110 from the other side of the hydraulic block 100.

The sleeve 300 includes a sleeve body 310. The sleeve body 310 has a tubular shape with a hollow portion 311 formed along the longitudinal direction. In the present exemplary embodiment, the sleeve body 310 has a cylindrical shape. When the sleeve 300 is inserted into the coupling hole 110, an outer circumferential surface of a partial region of the sleeve body 310 comes into close contact with the coupling hole 110.

The piston member 220 is inserted into the hollow portion 311 of the sleeve body 310. That is, the hollow portion 311 of the sleeve body 310 forms a path for the piston member 220 to move forward and backward.

The hollow portion 311 of the sleeve 300 is divided into two oil chambers 301 and 302 while the piston member 220 moves forward and backward. One oil chamber 301 of the oil chambers 301 and 302 is supplied with oil from a forward chamber of the reservoir 10, and the other oil chamber 302 of the oil chambers 301 and 302 is supplied with oil from a backward chamber of the reservoir 10.

A side (one side) opposite to the side (other side) from which the sleeve body 310 is inserted into the coupling hole 110 is formed with a damping member coupling part 320 so that the damping member 500 can be coupled thereto.

The damping member coupling part 320 includes a damping member contact surface 321 and a stepped surface 322. The damping member contact surface 321 has a diameter smaller than that of an outer circumferential surface of the sleeve body 310. The damping member 500 is coupled to the sleeve 300 while the damping member coupling part 320 is inserted into the hollow portion 511.

When the damping member 500 and the sleeve 300 are coupled, the damping member contact surface 321 comes into contact with an inner circumferential surface of the damping member 500.

The stepped surface 322 is formed connecting the damping member contact surface 321 and an outer circumferential surface (not shown) of the sleeve body 310. When the damping member 500 is coupled with the sleeve 300, a position where the damping member 500 is coupled may be fixed by the stepped surface 322.

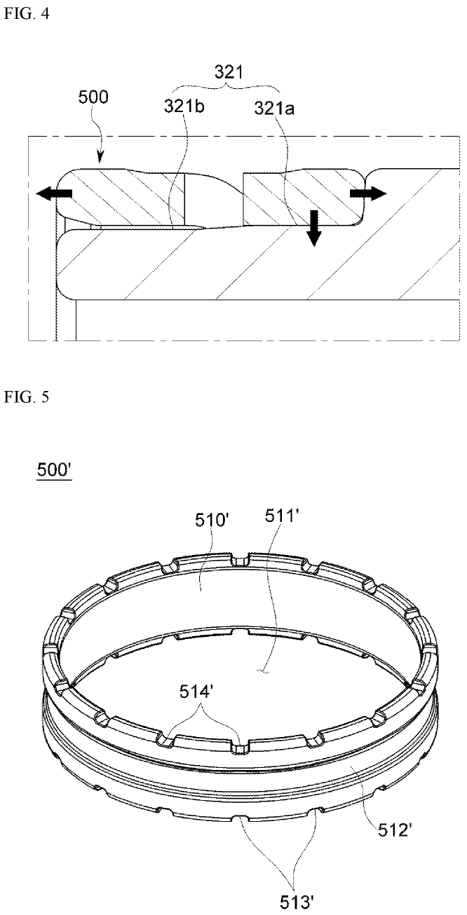

The damping member contact surface 321 does not come into contact with the inner circumferential surface of the damping member 500 as a whole. The damping member contact surface 321 includes a contact surface 321a and a separation surface 321b. Referring to FIG. 4, a structure of the damping member contact surface 321 can be seen in detail.

The contact surface 321a has a cross section formed to be uniform in size by a set length from the stepped surface 322 toward one side of the sleeve 300. The separation surface 321b is formed such that a cross section gradually decreases in size from the contact surface 321a to one side of the sleeve 300.

Due to such a shape, when the damping member 500 is coupled to the damping member coupling part 320, an inner circumferential surface of the damping member 500 comes into close contact with the contact surface 321a and is separated from the separation surface 321b.

The housing 400 is inserted and coupled into the hydraulic block 100 from the other side of the hydraulic block 100. Like the sleeve 300, the housing is inserted into the coupling hole 110 from the other side of the hydraulic block 100.

The housing 400 forms a space, i.e., oil chambers 301 and 302 in which the oil supplied from the reservoir 10 generates hydraulic pressure, while shielding the other side of the sleeve 300.

The housing 400 includes a first side surface 410, a second side surface 420, and a partition wall 430. The first side surface 410 is a surface extending in a direction parallel to the longitudinal direction of the sleeve 300. A part of the first side surface 410 is inserted into the coupling hole 110, and an outer circumferential surface of the first side surface 410 is in close contact with an inner circumferential surface of the coupling hole 110.

The second side surface 420 is a surface formed connecting one of one side and the other side of the first side surface 410 to shield any one side of the housing 400. In the present exemplary embodiment, the second side surface 420 is formed on a side opposite to a side where the first side surface 410 is inserted into the coupling hole 110.

The partition wall 430 is formed at a center of the second side surface 420. The partition wall 430 extends in a direction parallel to the longitudinal direction of the first side surface 410 at a position spaced apart from the first side surface 410 by a set distance along a radial direction. The partition wall 430 has a hollow portion therein. In an inner space of the partition wall 430, a motor position detection sensor unit 600 is provided.

Similar to the contact surface 321a of the sleeve 300, the housing 400 is brought into close contact with the damping member 500 only at a part of a region in contact with the damping member 500. Specifically, a cross section of the first side surface 410 from a side connecting to the second side surface 420 to a set length is formed uniform in size. A region where the cross section is formed uniform in size comes into close contact with an outer circumferential surface of the damping member 500.

A size of the cross section from an end of the region where the cross section is formed uniform in size to a set length gradually increases. Therefore, the region where the size of the cross section gradually increases is spaced apart from the outer circumferential surface of the damping member 500.

The sleeve 300 and the housing 400 are partially spaced apart to form a flow path, and the oil supplied from the reservoir 10 flows into the oil chamber 301 along the flow path.

The damping member 500 is provided between the sleeve 300 and the housing 400.

The sleeve 300 and the housing 400 are minutely spaced apart. When the piston member 220 of the motor pump unit 200 moves forward and backward, the pressure in a space where hydraulic pressure is generated, in particular, in the oil chamber 301 rises. As a result, vibration is generated or noise due to vibration is generated between the sleeve 300 and the housing 400.

Meanwhile, the sleeve 300 and the housing 400 may be provided in each configuration as in the present exemplary embodiment, or may be provided in the form of a housing unit.

The damping member 500 is provided between the sleeve 300 and the housing 400 to prevent vibration or to prevent noise by absorbing vibration when vibration is generated as described above.

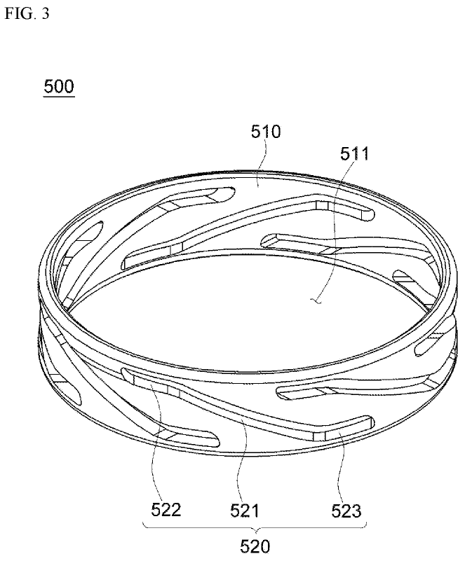

FIG. 3 is a perspective view showing the damping member 500 according to an exemplary embodiment of the present disclosure.

The damping member 500 includes a damping body 510 and a slit 520. The damping body 510 has a tubular shape with a hollow portion 511 along the longitudinal direction so that the sleeve 300 can be inserted and coupled therein. In the present embodiment, as shown in FIG. 3, the damping body 510 has a cylindrical shape.

The slit 520 is formed in the damping body 510. The slit 520 is formed penetrating through an inside and outside of the damping body 510. The slit 520 is formed in plural spaced apart from each other by a set distance along the circumferential direction of the damping body 510.

The slit 520 includes an inclined portion 521, a first extension portion 522 and a second extension portion 523. The inclined portion 521 is formed to be inclined downward from an upper side toward a lower side of the damping body 510.

The first extension portion 522 extends by a set length along a circumferential direction of the damping body 510 from any one of the upper and lower sides of the inclined portion 521. The second extension portion 523 extends by a set length along the circumferential direction of the damping body 510 from the other of the upper and lower sides of the inclined portion 521.

The slit 520 is formed so that the damping body 510 can be elastically deformed. The damping member 500 according to the present exemplary embodiment is formed of a plastic material. Due to the nature of the material, the damping member 500 does not have elasticity, but can be elastically deformed due to the slit 520.

On the other hand, if the slit 520 is made of only the inclined portion 521, stress may be concentrated on both sides of the inclined portion 521, causing a damage. In the present exemplary embodiment, the first extension portion 522 and the second extension portion 523 are formed on both sides of the inclined portion 521, thereby dispersing stress concentrated on the inclined portion 521.

A height of the damping member 500 may be formed longer than that of the damping member contact surface 321. The height of the damping member 500 is formed longer than that of the damping member contact surface 321, so that, even if the sleeve 300 moves slightly when the piston member 220 moves forward and backward, it can be prevented from colliding with the housing 400.

An example in which the damping member 500 according to the exemplary embodiment of the present disclosure as described above is applied to the hydraulic pressure supply device 1000 is shown in FIG. 4. Arrows in FIG. 4 show directions in which the damping member 500 transfers load to the sleeve 300 and the housing 400.

As such, since the damping member 500 transfers the load to the sleeve 300 and the housing 400, vibration is prevented from being generated between the sleeve 300 and the housing 400, and noise due to vibration can also be prevented.

FIG. 5 shows a damping member 500′ according to another exemplary embodiment of the present disclosure.

The damping member 500′ according to another exemplary embodiment of the present disclosure includes a damping body 510′. The damping body 510′ has a tubular shape with a hollow portion 511′ along the longitudinal direction, as in the exemplary embodiment described above. Specifically, in the present exemplary embodiment, the damping member 500′ has a cylindrical shape in which a hollow 511′ is formed.

The damping body 510′ includes a first groove 512′, a second groove 513′, and a third groove 514′.

The first groove 512′ is formed concave on an outer circumferential surface of the damping body 510′ in a direction toward an inner circumferential surface, and extends along a circumferential direction of the damping body 510′.

The second groove 513′ is formed on an upper side of the damping body 510′. Specifically, the second groove is formed concave on the upper side of the damping body 510′ toward a lower side by a set depth. The second groove 513′ is formed in plural spaced apart from each other by a set angle along the circumferential direction of the damping body 510′.

The third groove 514′ is formed on a lower side of the damping body 510′. Specifically, the third groove is formed concave on the lower side of the damping body 510′ toward the upper side by a set depth. The third groove 514′ is formed in plural spaced apart from each other by a set angle along the circumferential direction of the damping body 510′.

The first groove 512′, the second groove 513′, and the third groove 514′ are formed for a filling ratio of the damping member 500′. Unlike the exemplary embodiment described above, the damping member 500′ is made of a rubber material.

The damping member 500′ made of a rubber material expands when pressure and temperature increase inside the hydraulic pressure supply device. Therefore, when the damping member 500′ is provided in a space between the sleeve 300 and the housing 400, a ratio occupied by the damping member 500′ with respect to the space should be equal to or less than a certain standard. Here, the ratio occupied by the damping member 500′ with respect to the space is the filling ratio.

That is, the first groove 512′, the second groove 513′, and the third groove 514′ are formed in preparation for expansion of the damping member 500′.

Like the damping member 500 according to the exemplary embodiment described above, the damping member 500′ according to the present exemplary embodiment is also in close contact with the contact surface 321a and is spaced from the separation surface 321b on an inner circumferential surface of the damping body 510′.

If the damping member 500′ is in close contact with the entire damping member contact surface 321, it is difficult for the damping member 500′ to be elastically deformed and thus vibration may not be absorbed well. However, as in the present exemplary embodiment, only a part of the damping member 500′ is in close contact with the damping member contact surface 321, so that the damping member 500′ is elastically deformed to better absorb vibration and to prevent noise.

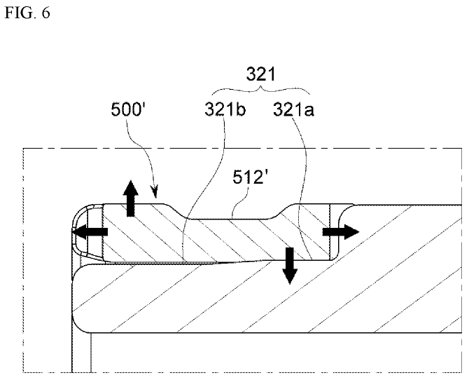

FIG. 6 shows an example in which the damping member 500′ of FIG. 5 is applied to the hydraulic pressure supply device 1000. Arrows indicated in FIG. 6 show directions in which the damping member 500′ transfers the load to the sleeve 300 and the housing 400.

Since the damping member 500′ transfers the load to the sleeve 300 and the housing 400 in the directions indicated by the arrows, vibration is prevented from being generated between the sleeve 300 and the housing 400, and even if vibration is generated, the damping member 500′ absorbs it, so that noise caused by the vibration can be prevented.

Although the exemplary embodiments of the present disclosure have been described with reference to the accompanying drawings, one skilled in the art to which the present disclosure belongs can understand that the present disclosure can be implemented in other specific forms without changing the technical spirit or essential features.

Therefore, the exemplary embodiments described above should be understood as illustrative and not restrictive in all respects, the scope of the present disclosure is defined by the claims to be described later, and all changes or modified forms derived from the meaning and scope of the claims and equivalent concepts thereof should be construed as being included in the scope of the present disclosure.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

### EXPLANATION OF REFERENCES

1: brake pedal
10: reservoir
20: master cylinder
30: pedal simulator
40: hydraulic circuit unit
50: wheel cylinder
60: electronic control unit
1000: hydraulic pressure supply device
100: hydraulic block
200: motor pump unit
210: motor member
220: piston member
300: sleeve
400: housing
500,500′: damping member

What is claimed is:

1. A hydraulic pressure supply device comprising:
a hydraulic block formed with a flow path through which oil supplied from a reservoir flows;
a motor pump unit coupled to one side of the hydraulic block, configured to generate drive force by supply of power and to move forward and backward by the drive force;
a sleeve coupled to an inside of the hydraulic block on the other side of the hydraulic block and configured to form a forward and backward path of the motor pump unit;
a housing coupled to the other side of the hydraulic block and configured to form a space for generating hydraulic pressure with the oil supplied from the reservoir while shielding the other side of the sleeve; and
a damping member provided between the sleeve and the housing and configured to absorb vibration generated between the sleeve and the housing and to prevent noise when pressure in the space for generating the hydraulic pressure rises due to the forward and backward movement of the motor pump unit.

2. The hydraulic pressure supply device according to claim 1, wherein the damping member comprises:
a tubular damping body having a hollow portion formed along a longitudinal direction so that the sleeve is able to be inserted and coupled thereto; and
a slit formed through an inside and outside of the damping body.

3. The hydraulic pressure supply device according to claim 2, wherein the slit is formed in plural, spaced apart from each other by a set distance along a circumferential direction of the damping body.

4. The hydraulic pressure supply device according to claim 3, wherein the slit comprises:
an inclined portion formed to be inclined downward from an upper side toward the other side;
a first extension portion extending by a set length along the circumferential direction of the damping body from any one of the upper and lower sides of the inclined portion; and
a second extension portion extending by a set length along the circumferential direction of the damping body from the other of the upper and lower sides of the inclined portion.

5. The hydraulic pressure supply device according to claim 4, wherein the sleeve comprises a tubular sleeve body having a hollow portion along a longitudinal direction, and wherein the sleeve body has a damping member coupling part formed so that the damping member is able to be coupled by a set length from one side toward the other side.

6. The hydraulic pressure supply device according to claim 5, wherein the damping member coupling part comprises:
a damping member contact surface having a diameter smaller than a diameter of an outer circumferential surface of the sleeve body and configured to be in contact with an inner surface of the damping member; and
a stepped surface configured to connect the damping member contact surface and an outer surface of the sleeve body.

7. The hydraulic pressure supply device according to claim 6, wherein the damping member contact surface comprises:
a contact surface whose cross section is formed to be uniform by a set length from the stepped surface toward one side of the sleeve; and
a separation surface whose cross section is formed to gradually decrease from the contact surface to one side of the sleeve.

8. The hydraulic pressure supply device according to claim 6, wherein an inner surface of the damping member is configured to be in close contact with the contact surface when the damping member is coupled to the damping member coupling part.

9. The hydraulic pressure supply device according to claim 2, wherein a height of the damping member is formed longer than a height of the damping member contact surface.

10. The hydraulic pressure supply device according to claim 1, wherein the damping member is formed of a plastic material.

11. The hydraulic pressure supply device according to claim 1, wherein the damping member comprises a tubular damping body having a hollow portion formed along a longitudinal direction so that the sleeve is able to be inserted and coupled thereto.

12. The hydraulic pressure supply device according to claim 11, wherein the damping body comprises:
a first groove formed concave on an outer surface and extending along a circumferential direction of the damping body;
a plurality of second grooves formed concave on an upper side toward a lower side by a set depth, and spaced apart from each other by a set angle along a circumferential direction of the damping body; and
a plurality of third grooves formed to be concave on a lower side toward the upper side by a set depth, and spaced apart from each other by a set angle along the circumferential direction of the damping body.

13. The hydraulic pressure supply device according to claim 11, wherein the damping member is formed of a rubber material.

14. The hydraulic pressure supply device according to claim 1, wherein the motor pump unit comprises:
a motor coupled to one side of the hydraulic block and configured to generate drive force by supply of power; and
a pump member inserted into the hydraulic block from one side of the hydraulic block and configured to move forward and backward by the drive force generated by the motor.

15. An electronic brake system comprising:
a reservoir in which oil is stored;
a master cylinder configured to provide a pedal feeling to a driver while discharging the oil by an operation of a brake pedal; and
a hydraulic pressure supply device configured to generate hydraulic pressure by actuating a hydraulic piston by an electrical signal that is output in response to displacement of the brake pedal,
wherein the hydraulic pressure supply device comprises:
a hydraulic block formed with a flow path through which the oil supplied from the reservoir flows;
a motor coupled to one side of the hydraulic block, and configured to generate drive force by supply of power;
a pump member coupled into the hydraulic block from one side of the hydraulic block and configured to move forward and backward by the drive force provided by the motor; and
a housing unit configured to form a path through which the pump member moves forward and backward and to form a space for generating hydraulic pressure by storing the oil, and coupled into the hydraulic block from the other side of the hydraulic block, and
wherein the housing unit comprises a damping member configured to absorb vibration and to prevent noise generated while pressure in the space for generating the hydraulic pressure rises due to the forward and backward movement of the pump member.

16. The electronic brake system according to claim 15, wherein the housing unit comprises:
a sleeve inserted into the hydraulic block from the other side of the hydraulic block and configured to form a path through which the pump member moves forward and backward; and
a housing coupled to the other side of the hydraulic block and configured to form a space for generating hydraulic pressure by storing the oil while shielding the other side of the sleeve.

17. The electronic brake system according to claim 16, wherein the damping member comprises:
a tubular damping body having a hollow portion formed along a longitudinal direction so that the sleeve is able to be inserted and coupled thereto; and
a slit formed penetrating through an inside and outside of the damping body.

18. The electronic brake system according to claim 17, wherein the slit is formed in plural spaced apart from each other by a set distance along a circumferential direction of the damping body.

19. The electronic brake system according to claim 17, wherein the slit comprises:
an inclined portion formed to be inclined downward from an upper side toward the other side;
a first extension portion extending by a set length along the circumferential direction of the damping body from any one of the upper and lower sides of the inclined portion; and
a second extension portion extending by a set length along the circumferential direction of the damping body from the other of the upper and lower sides of the inclined portion.

20. The electronic brake system according to claim 19, wherein the sleeve comprises a tubular sleeve body having a hollow portion along a longitudinal direction, and
wherein the sleeve body has a damping member coupling part formed so that the damping member is able to be coupled by a set length from one side toward the other side.
